(19) United States
(12) Patent Application Publication
(10) Pub. No.: US 2018/0137530 A1
(43) Pub. Date: May 17, 2018

(54) Systems and Methods for Use in Selecting Accounts Based on Incentives Associated With the Accounts

(71) Applicant: MASTERCARD INTERNATIONAL INCORPORATED, Purchase, NY (US)

(72) Inventors: Joel Chris Wheeler, Ballwin, MO (US); Kyle P. Clark, High Ridge, MO (US); Jason Hilliard Goodgold, Wildwood, MO (US)

(21) Appl. No.: 15/352,084

(22) Filed: Nov. 15, 2016

(51) Int. Cl. G06Q 30/02; G06Q 20/22; G06Q 20/10

(52) U.S. Cl. CPC G06Q 30/0222; G06Q 20/108; G06Q 20/227

(57) ABSTRACT

Systems and methods are provided for facilitating payment account transactions, through selection of particular payment accounts for use in the transactions based on incentives associated with the payment accounts. One exemplary method includes receiving an authorization request for a transaction, where the authorization request includes a virtual card number (VCN) for a virtual wallet used in the transaction, and a parameter of the transaction. The method also includes selecting a payment account, from multiple payment accounts in the virtual wallet, based on an incentive associated with the payment account and the parameter, and replacing the VCN in the authorization request with a primary account number (PAN) for the selected payment account. The method then further includes routing the authorization request, with the appended PAN, to an issuer associated with the selected payment account so that the transaction may be subjected to the incentive associated with the payment account.

### FIELD

The present disclosure generally relates to systems and methods for use in selecting accounts based on incentives associated with the accounts, and in particular, to systems and methods for use in replacing virtual card numbers in authorization requests for transactions with primary account numbers associated with particular payment accounts based on incentives associated with the payment accounts and the transactions.

### BACKGROUND

This section provides background information related to the present disclosure which is not necessarily prior art.

Consumers are known to use payment accounts to purchase various different products from merchants (e.g., good and services, etc.). The payment accounts may include credit payment accounts, for which issuers of the accounts provide credit to the consumers for use in purchasing the products. Or, the payment accounts may include debit or prepaid payment accounts, to which the consumers add funds for use in purchasing the products. For credit payment accounts, the consumers often pay interest on balances outstanding according to certain terms. Conversely, for debit payment accounts, for example, the consumers may earn interest on balances maintained in the payment accounts. The payment accounts, regardless of type, may further be associated with incentives, such as, for example, cash back on purchases, reward points for purchases, and/or benefits relating to certain purchases. In one example, a payment account may include a one percent cash back incentive on all purchases performed using the payment account, while in another example, a payment account may include extended warranties or travel insurance for certain purchases performed using the payment account.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in selecting payment accounts based on incentives associated with the payment accounts;

FIG. 2 is a block diagram of a computing device that may be used in the exemplary system of FIG. 1;

FIG. 3 is an exemplary method, which may be implemented in the system of FIG. 1, for generating at least one rule for incentives associated with a payment account; and

FIG. 4 is an exemplary method, which may be implemented in the system of FIG. 1, for selecting a payment account for use in a purchase transaction based on incentives associated with the payment account.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Products (e.g., goods and/or services, etc.) are often purchased by consumers from merchants in purchase transactions through use of payment accounts. The payment accounts are often associated with incentives, such as, for example, rewards, cash back, other benefits, etc., to encourage the consumers to use the payment accounts (verses using other payment accounts) when performing the purchase transactions. When a consumer is associated with multiple payment accounts, it may be difficult for the consumer to recall the particular incentives associated with each of the payment accounts and to select one of the multiple payment accounts, verses others, to capture the most applicable incentives (or even maximize the incentives). Uniquely, the systems and methods herein permit rules to be implemented by payment networks, for example, to automatically select payment accounts to be used for transactions to potentially maximize incentives for the corresponding purchase transaction. In particular, when a consumer initiates a transaction, through a virtual wallet, for example, the virtual wallet passes a virtual card number (VCN) to the merchant, which in turn transmits an authorization request for the transaction with the VCN. The payment network intercepts the authorization request and, based thereon, selects one of the consumer's payment accounts from the virtual wallet for the transaction based on one or more rules (e.g., based on application of the one or more rules to various parameter(s) included in the authorization request, etc.). The payment network then replaces the VCN with the primary account number (PAN) for the selected payment account, and routes the authorization request to the issuer of the selected payment account. The payment network further converts the PAN back the VCN in the authorization reply from the issuer. In this manner, the consumer and/or the payment network may dictate the particular conditions upon which one payment account in the consumer's virtual wallet is used over one or more other payment accounts, based on the one or more rules implemented by the payment network as they pertain to incentives associated with the various payment accounts. As such, the consumer and/or payment network may be able to increase, or potentially maximize, the incentives awarded to the consumer for the transaction performed using the virtual wallet.

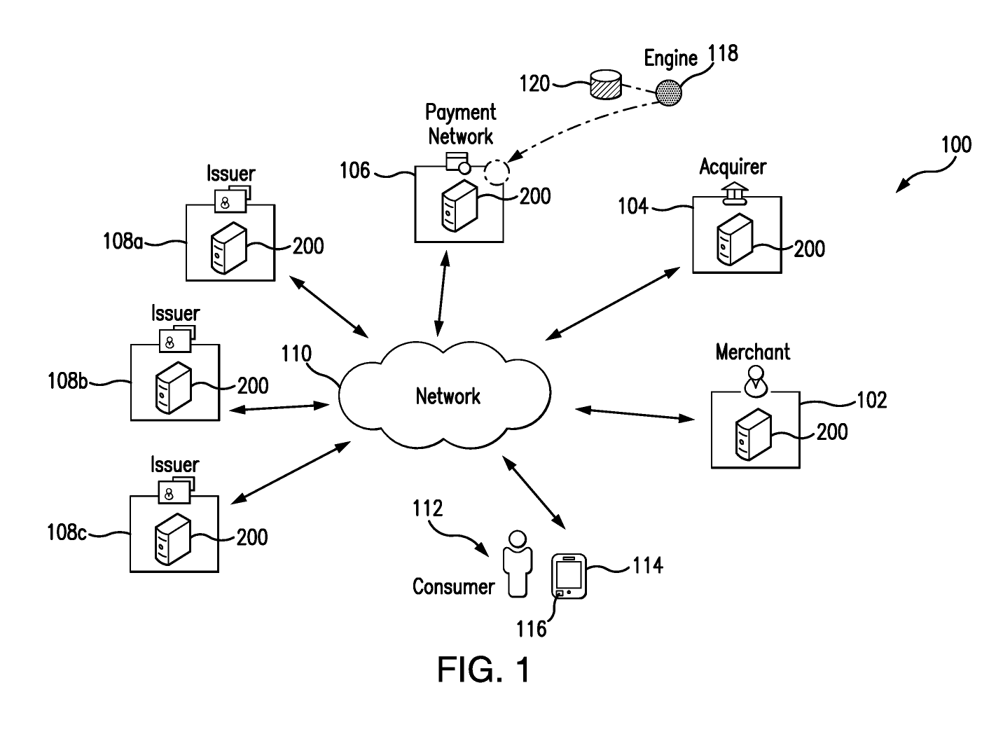

FIG. 1 illustrates an exemplary system 100, in which the one or more aspects of the present disclosure may be implemented. Although the system 100 is presented in one arrangement, other embodiments may include the parts of the system (or other parts in general) arranged otherwise depending on, for example, payment accounts included in consumers' virtual wallets, entities involved in selecting payment accounts, etc.

As shown in FIG. 1, the system 100 generally includes a merchant 102, an acquirer 104 associated with the merchant 102, a payment network 106, and multiple issuers 108a-c configured to issue payment accounts to consumers, each of which is coupled to (and is in communication with) network 110. The network 110 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, network 110 may include multiple different networks, such as a private payment transaction network made accessible by the payment network 106 to the acquirer 104 and the issuers 108a-c and, separately, the public Internet, which may provide interconnection between the merchant 102, the payment network 106, the issuers 108a-c, and/or a consumer 112 (specifically, a communication device 114 associated with a consumer 112), etc.

The merchant 102 is generally associated with products (e.g., goods and/or services, etc.) offered for sale to consumers (e.g., the consumer 112, etc.). It should be appreciated that the merchant 102 may include any desired type of merchant, and that various types of merchants, large or small, single store or multi-store, permanent, mobile, and/or temporarily located, which offer various different kinds of products for sale, are within the scope of the present disclosure. The merchant 102 and other merchants are generally associated with a merchant category code or MCC. In general, the MCC indicates a general category of products offered by the merchant 102. For example, MCC 5732 indicates that the corresponding merchant is an electronics retailer, while MCC 5542 indicates that the corresponding the merchant is a fuel dispenser and MCC 5411 indicates that the corresponding merchant is a grocery store.

In this exemplary embodiment, the issuers 108a-c each issue a payment account for the consumer 112. Each of the payment accounts includes an incentive (or multiple incentives) for using the payment account to purchase products, where the incentives are subject to one or more conditions. The incentives may include rewards (e.g., cash back, points, miles, etc.), and/or the incentives may include benefits (e.g., extended warranties, travel insurance, etc.). For example, as used herein, the payment account issued by the issuer 108a (i.e., the 108a payment account) provides rewards for transactions at grocery stores performed using the 108a payment account (e.g., 2% cash back for grocery store transactions, etc.), and the payment account issued by the issuer 108b (i.e., the 108b payment account) offers rewards for all transaction performed using the 108b payment account (e.g., 1 point per $1 spent for all transactions, etc.). And, the payment account issued by the issuer 108c (i.e., the 108c payment account) provides extended warranties for electronics purchases performed using the 108c payment account. These exemplary incentives for the 108a-c payment accounts are summarized in Table 1. It should be appreciated, however, that in other embodiments a variety of different incentives may be associated with payment accounts within the scope of the present disclosure.

TABLE 1

| Payment account | Incentive |
|---|---|
| 108a Payment account | 2% cash back for grocery store |
| | transactions, based on MCC 5411 |
| 108b Payment account | 1 point per $1 spent for all transactions |
| 108c Payment account | Extended warranty for electronic |
| | purchases, as indicted by MCC 5732 |

With continued reference to FIG. 1, the consumer 112 is associated with the communication device 114, which may include, for example, a tablet, a smartphone, a laptop, or another communication device, etc. The communication device 114 is generally, in this embodiment, a portable communication device. As shown, the communication device 114 includes an application 116, which is installed and active in the communication device 114 to thereby configure the communication device 114 (e.g., via computer-executable instructions, etc.) to operate as described herein. In particular, the application 116 includes a virtual wallet application such as, for example, MasterPass®, Apple Pay®, Samsung Pay®, PayPal®, Google Wallet®, Android Wallet™, etc. As such, the application 116 generally permits payment accounts (e.g., the 108a-c payment accounts, etc.) to be appended to the virtual wallet and then made available for use by the consumer 112 at the merchant 102, or at other merchants, to initiate payment account transactions and/or otherwise interact with the merchant(s). In this exemplary embodiment, the consumer 112 has appended the 108a-c payment accounts issued by each of the issuers 108a-c to the virtual wallet application 116, such that any of which is able to be used, by the consumer 112, to fund purchase transactions (through the application 116). In connection therewith, the virtual wallet application 116 includes a virtual card number (VCN) that is generally associated with a consumer, but is not associated with or indicative of any one of the 108a-c payment accounts included in the virtual wallet application 116. With that said, when the communication device 114 is described as configured to perform various operations herein, it should be appreciated that it may be doing so generally in coordination with the application 116 (even if the application 116 is not specifically referenced), or not.

While one merchant 102, one acquirer 104, one payment network 106, three issuers 108a-c, one consumer 112, and one communication device 114 are illustrated in FIG. 1, it should be appreciated that any number of these parts (and their associated parts, including third parties) may be included in the system 100, or may be included as one or more parts of systems in other embodiments, consistent with the present disclosure. In fact, often multiple ones or even hundreds of one or more of these parts may be included in system embodiments of the present disclosure.

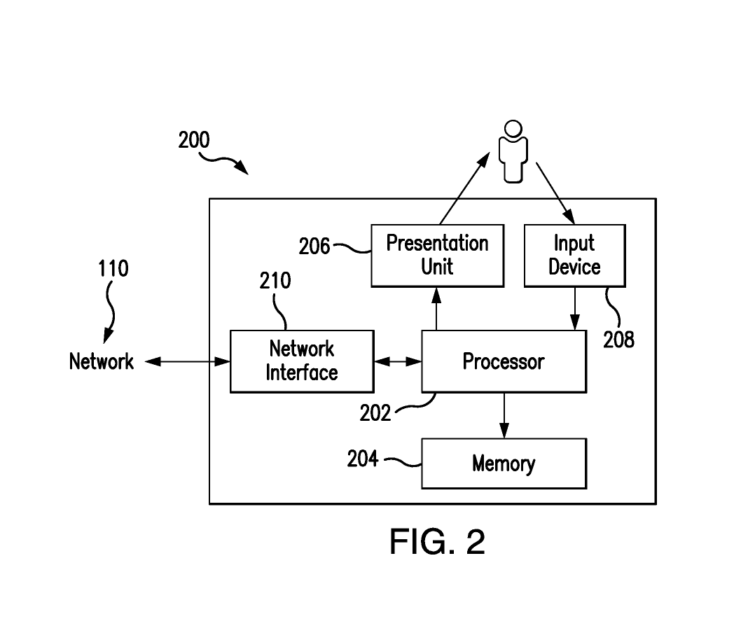

FIG. 2 illustrates an exemplary computing device 200 that can be used in the system 100. The computing device 200 may include, for example, one or more servers, workstations, personal computers, laptops, tablets, smartphones, PDAs, point-of-sale devices, etc. In addition, the computing device 200 may include a single computing device, or it may include multiple computing devices located in close proximity to or distributed over a geographic region, so long as the computing devices are specifically configured to operate as described herein. In the exemplary embodiment of FIG. 1, each of the merchant 102, the acquirer 104, the payment network 106, and the issuers 108a-c is illustrated as including, or being implemented in, computing device 200, coupled to the network 110. In addition, the communication device 114, which is associated with consumer 112, can also be considered a computing device consistent with computing device 200 for purposes of the description herein. However, the system 100 should not be considered to be limited to the computing device 200, as described below, as different computing devices and/or arrangements of computing devices may be used. In addition, different components and/or arrangements of components than illustrated herein may be used in other computing devices.

Referring to FIG. 2, the exemplary computing device 200 includes a processor 202, and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transaction data, incentives (and associated conditions), rules, PANs, VCNs, interfaces and/or other types of data (and/or data structures) suitable for use as described herein. Furthermore, in various embodiments, computer-executable instructions may be stored in the memory 204 for execution by the processor 202 to cause the processor 202 to perform one or more of the operations described herein, such that the memory 204 is a physical, tangible, and non-transitory computer readable storage media. Such instructions often improve the efficiencies and/or performance of the processor 202 that is performing one or more of the various operations herein. It should be appreciated that the memory 204 may include a variety of different memories, each implemented in one or more of the operations described herein.

In the exemplary embodiment, the computing device 200 includes a presentation unit 206 that is coupled to (and is in communication with) the processor 202 (however, it should be appreciated that the computing device 200 could include output devices other than the presentation unit 206, etc.). The presentation unit 206 outputs information (e.g., payment account data, notifications of selected payment accounts, incentives, etc.), visually, for example, to a user of the computing device 200 such as to the consumer 112 in the system 100, to a representatives associated with the merchant 102, etc. It should be further appreciated that various interfaces (e.g., as defined by network-based applications (e.g., application 116, etc.), websites, etc.) may be displayed at computing device 200, and in particular at the presentation unit 206, to display such information. The presentation unit 206 may include, without limitation, a liquid crystal display (LCD), a light-emitting diode (LED) display, an organic LED (OLED) display, an “electronic ink” display, speakers, etc. In some embodiments, presentation unit 206 includes multiple devices.

The computing device 200 also includes an input device 208 that receives inputs from the user of the computing device 200 (i.e., as user inputs) such as, for example, rule inputs, account selections, incentive preferences, etc. The input device 208 is coupled to (and is in communication with) the processor 202 and may include, for example, a keyboard, a pointing device, a mouse, a stylus, a camera, a biometric scanner, a touch sensitive panel (e.g., a touch pad or a touch screen, etc.), another computing device, and/or an audio input device. Further, in various exemplary embodiments, a touch screen, such as that included in a tablet, a smartphone, or similar device, may behave as both a presentation unit and an input device.

In addition, the illustrated computing device 200 also includes a network interface 210 coupled to (and in communication with) the processor 202 and the memory 204. The network interface 210 may include, without limitation, a wired network adapter, a wireless network adapter (e.g., a Wi-Fi adapter, a NFC adapter, a Bluetooth adapter, etc.), a mobile network adapter, or other device capable of communicating to one or more different networks, including the network 110. Further, in some exemplary embodiments, the computing device 200 may include the processor 202 and one or more network interfaces incorporated into or with the processor 202.

Referring again to FIG. 1, the system 100 also includes an incentive engine 118, and a rules data structure 120 coupled to (and in communication with) the incentive engine 118. The incentive engine 118 is specifically configured, by executable instructions, to perform one or more of the operations herein. The incentive engine 118 is illustrated in the system 100 as a standalone part and, as such, may be implemented in and/or associated with a computing device consistent with computing device 200 (with the data structure 122 included in memory 204 therein, or separate). However, as indicated by the dotted lines, the incentive engine 118 may be incorporated, at least in part, with the payment network 106 (e.g., in association with the computing device 200 associated therewith, etc.). In addition, in still other embodiments, the incentive engine 118 may be incorporated, at least partly, elsewhere in the system 100 (e.g., in other parts of the system such as the merchant 102, the acquirer 104, etc.), or in other entities not shown.

In this exemplary embodiment, the incentive engine 118 is configured to enroll the consumer's virtual wallet (and associated application 116 at the consumer's communication device 114) with the incentive engine 118. This may be done by the incentive engine 118 upon installation of the virtual wallet application 116 to the communication device 114 (automatically, or upon authorization from the consumer 112). Or, this may be done as part of an additional service associated with the consumer's virtual wallet (or as part of adding new services to the consumer's virtual wallet). In so doing, the VCN for the consumer's virtual wallet may be stored in memory 204 associated with the incentive engine 118. Further, in other embodiments, virtual wallets associated with third-party providers (e.g., virtual wallets maintained at banks, etc.) may similarly enroll with the incentive engine 118 to implement the various features described herein, for example, by calling the incentive engine 118 via an application program interface (API). In so doing, the incentive engine 118 is configured to then enroll the virtual wallets as described herein, whereby the various features described herein relating to selections of accounts from the virtual wallets to optimize incentives, etc. are also applicable to the virtual wallets.

Regardless, when a payment account (e.g., one of the 108a-c payment accounts, etc.) is appended to the consumer's virtual wallet, the virtual wallet application 116 (at the consumer's communication device 114) is configured to indicate the addition of the payment account to the incentive engine 118 (whereby the incentive engine 118 may store one or more indicators of the payment account (e.g., a PAN, etc.) in memory 204 associated with the incentive engine 118, in association with the VCN for the virtual wallet application 116). In turn, the incentive engine 118 is configured to retrieve the incentives associated with the appended payment account. To do so, the incentive engine 118 may be configured to contact the issuer associated with the payment account (e.g., one of the issuers 108a-c, etc.) and request the incentives associated with, for example, the bank identification number (or BIN) or other segment of the PAN for the payment account. In some instances, the incentives may not be available from the issuer, whereby the incentive engine 118 may be configured to return a request to the consumer 112, at the virtual wallet application 116, to provide the incentives, which the consumer 112 may then submit through the virtual wallet application 116 (e.g., at the communication device 114, etc.).

Then, once the incentives for the particular payment account are received, the incentive engine 118 is configured to generate one or more rules for the added payment account, and/or for other payment accounts included in the virtual wallet application 116. In particular, for example, the incentive engine 118 is configured to determine, based on various conditions associated with incentives, which incentives are of greater value to the consumer 112 for different transactions. As such, in generating the one or more rules, the incentive engine 118 generally takes into account the incentive associated with the added payment account as well as incentives for other payment accounts included in the virtual wallet application (although this is not required in all embodiments). For example, rules generated by the incentive engine 118 may evaluate the different incentives (for the different payment accounts in the virtual wallet) based on the provided earn rates, where available (e.g., the earn rate of 2% for the 108a payment account verses the earn rate of 1 point per $1 spent for the 108b payment account, etc.). In so doing, the rules (e.g., via the incentive engine 118, etc.) translate the incentives to a base currency value, and compare the translated incentives. The highest value incentive is then selected for a given transaction. In the event of a tie, or in the event that some applicable incentives cannot be translated to the base currency for comparison (e.g., where the incentives include extended warranties, etc.), the incentive engine 118 is configured to then present the consumer 112 with the available payment account options for selection for a given transaction (e.g., via the application 116 at the communication device 114, etc.).

In the example embodiment of FIG. 1 (and as also illustrated above in Table 1), the 108a payment account offers 2% cash back for grocery purchases, while the 108b payment account offers 1 point per dollar spent on all purchases. And, the 108c payment account offers an extended warranty for electronic purchases. Based on the assumption that each point offered via the 108b payment account is worth $0.01, the incentive engine 118 may generate the following rules: (1) if the MCC of a transaction is 5411 (for grocery stores), the transaction should be directed to the 108a payment account; (2) if the MCC of the transaction is 5732 (for electronics), the transaction should be directed to the 108c payment account; and (3) all other transactions should be directed to the 108b payment account.

It should be appreciated that the rules generated by the incentive engine 118 (or potentially suggested by the consumer 112) may relate to various different transaction parameters. For example, as described above, the rules may relate to MCCs of the transactions. Additionally, or alternatively, the rules may relate to transaction parameters such as transaction amounts, transaction locations, transaction merchants, transaction dates/times, or any other data included in authorization requests for transactions, etc. In addition, individual rules may relate to multiple different transaction parameters. For example, a rule may specify that transactions involving MCC 5411 and having a transaction amount exceeding $50.00 be directed to the 108a payment account (while all other transactions are to be directed to either the 108b payment account or the 108c payment account, depending on their corresponding rules). Further, in various embodiments, when multiple rules generated by the incentive engine 118 may equally apply to the same transaction, the incentive engine 118 may order the rules in a particular hierarchy so that the payment account associated with the first listed rule is selected or, as described above, the incentive engine 118 may solicit a selection of the payment accounts directly from the consumer 112.

Once the rules are generated, the incentive engine 118 is configured to store them in the rules data structure 120. For example, the incentive engine 118 may store the rules in association with a consumer profile for the consumer 112. Or, the rules may be stored in association with the consumer's virtual wallet (e.g., in association with a profile for the consumer's virtual wallet, in association with the VCN for the consumer's virtual wallet, etc.).

In various embodiments, once the rules are generated, the incentive engine 118 may be configured to provide the rules to the consumer 112, at the virtual wallet application 116, for approval prior to implementing and/or storing the rules in the rules data structure 120. Additionally, or alternatively, the incentive engine 118 may be configured to solicit a selection of a rule from the consumer 112 where different ones of the consumer's payment accounts have incentives that are generally equal in value and/or are expressed in different denominations. For example, and as described above, because points and dollars are different denominations, the incentive engine 118 may be configured to solicit an input from the consumer 112 (e.g., an incentive preference, etc.), which is then used to generate a rule to direct certain transactions to one payment account over another (based on the consumer's incentive preference).

In addition, in various embodiments, the rules stored in the rules data structure 120 may be updated (e.g., by the incentive engine 118, etc.), to account for updates/changes in incentives associated with the 108a-c payment accounts. For example, the 108b payment account may additionally offer 2 points per dollar spent (or other incentive) at particular merchants (or categories of merchants) during different time frames. As such, to account for these additional incentives, the incentive engine 118 may be configured to periodically update the incentives (e.g., receive updates relating to the incentives, etc.) and update the rules so that the consumer 112 can properly benefit therefrom.

Subsequently in the system 100, in use, the consumer 112 may present the virtual wallet application 116, via the communication device 114 (e.g., via NFC communication, etc.), to the merchant 102, for example, in connection with a transaction to purchase one or more products from the merchant. In response, the merchant 102 compiles an authorization request for the transaction. Specifically, the virtual wallet application 116 provides a VCN to the merchant 102, which is compiled into the authorization request. The authorization request is then transmitted to the acquirer 104, and on to the payment network 106 (e.g., to MasterCard®, Visa®, Discover®, etc.). In turn, the payment network 106 is configured to determine if the authorization request includes a VCN or a PAN (where the VCN may or may not have the same format as the PAN). If it includes a PAN, the payment network 106 is configured to permit the authorization request to proceed to the appropriate issuer of the account, as associated with the PAN (e.g., one of the issuers 108a-c, etc.). The issuer is configured to determine whether the payment account is in good standing and whether there is sufficient credit or funds to complete the purchase. As such, in response to the authorization request, the issuer is configured to return an authorization reply, indicating approved or decline of the transaction, to the merchant 102 (via the payment network 106 and the acquirer 104). If approved, the transaction is later cleared and/or settled by and between the merchant 102 and the acquirer 104 (via an agreement between the merchant 102 and the acquirer 104), and by and between the acquirer 104 and the issuer (via an agreement between the acquirer 104 and the issuer).

If the authorization request includes a VCN, the payment network 106 is instead configured to direct the authorization request to the incentive engine 118. The incentive engine 118, then, is configured to identify the various payment accounts associated with the VCN (e.g., in the rules data structure 120 or otherwise, etc.) and, based on the rules in the rules data structure 120 for the VCN, select one of the payment accounts for use in the transaction. As described above, the rules often rely on a parameter of the transaction, such as, for example, an MCC included in the transaction, an amount of the transaction, etc. In general, the rules (depending on the particular transaction) will provide for the consumer 112 to receive a better incentive, or the best available incentive, or a preferred incentive, for the transaction. In any case, once the payment account is selected, the incentive engine 118 is configured to replace the VCN in the authorization request with the PAN for the selected payment account and to route the authorization request to the issuer associated with the selected payment account.

In turn, the issuer (e.g., one of the issuers 108a-c, etc.), upon receipt of the authorization request (regardless of whether based on a PAN or a VCN) is configured to determine whether the payment account is in good standing and whether there is sufficient credit or funds to complete the purchase. The issuer is configured to then return an authorization reply, indicating approved or decline of the transaction, to the payment network 106, whereupon it is routed to the incentive engine 118. The incentive engine 118 is configured to replace the PAN with the VCN and to route the authorization reply to the merchant 102, via the acquirer 104. The transaction is later cleared and/or settled by and between the merchant 102 and the acquirer 104 (via an agreement between the merchant 102 and the acquirer 104), and by and between the acquirer 104 and the issuer (via an agreement between the acquirer 104 and the issuer) (e.g., where the payment network 106 facilitates translation of the VCN to the PAN and vice versa, etc.).

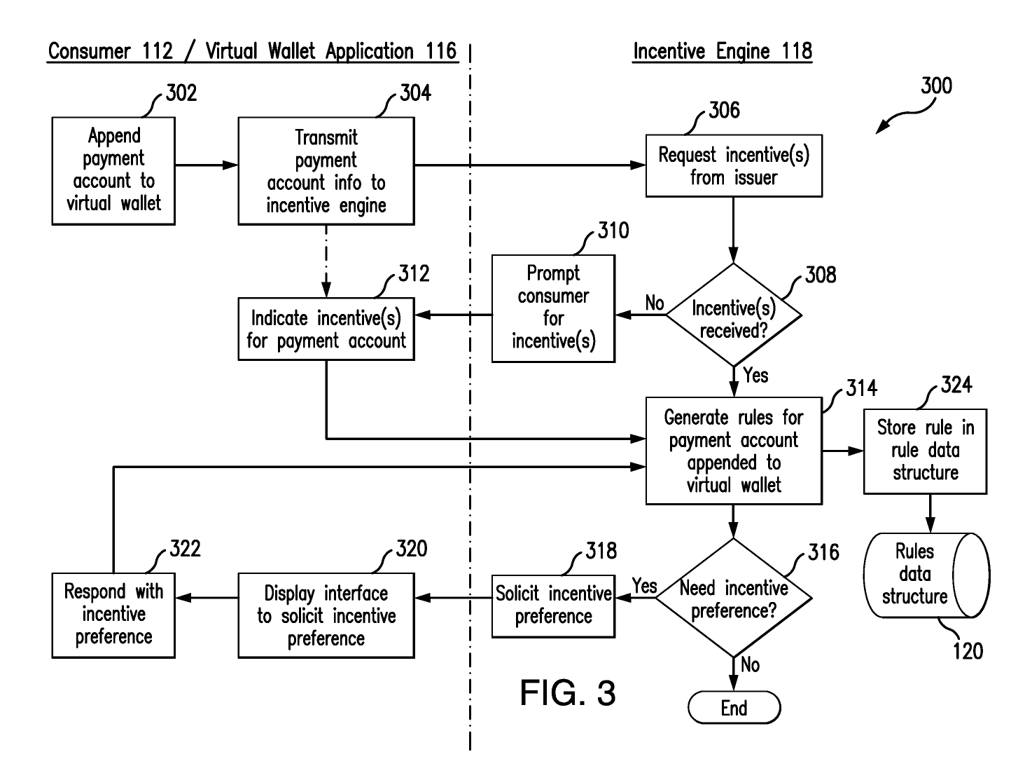

FIG. 3 illustrates an exemplary method 300 for generating a rule (or multiple rules) in association with incentives for a payment account, in connection with registering the payment account with the incentive engine 118 of the system 100. In connection therewith, the exemplary method 300 is described as implemented in the incentive engine 118, in association with the consumer's communication device 114 and the virtual wallet application 116. However, it should be understood that the method 300 is not limited to this configuration, as the method 300 may be implemented in other parts of the system 100. It should also be appreciated that the methods herein are not limited to the exemplary system 100 or the exemplary computing device 200, and likewise, the systems and the computing devices herein should not be understood to be limited to the exemplary method 300.

In the method 300, the virtual wallet application 116, as included at the communication device 114 associated with the consumer 112, is enrolled with the incentive engine 118 (as described above). As such, the consumer's virtual wallet application 116 generally performs as illustrated in the method 300 of FIG. 3 and as described herein.

As shown in FIG. 3, when the consumer 112 desires to add a new payment account to the virtual wallet application 116 (the 108a payment account in the following description) for use in purchase transactions through the application 116, he/she (via the communication device 114) initially appends the 108a payment account to the virtual wallet application 116, at 302. Upon receipt of the 108a payment account information (e.g., a PAN, an expiration date, a name, etc.), in the method 300, the virtual wallet application 116 (through the communication device 114) transmits, at 304, the 108a payment account information to the incentive engine 118. In response, at 306, the incentive engine 118 requests incentives for the 108a payment account from the issuer 108a.

Next, the incentive engine 118 determines, at 308, whether the appropriate incentives have been received from the issuer 108a, for the newly added 108a payment account. If the incentives are not received from the issuer 108a, the incentive engine 118 solicits, at 310, the incentives from the consumer 112, via the virtual wallet application 116. And, in response, the consumer 112 provides the appropriate incentives, via the application 116 (and the communication device 114), at 312. In this example, the incentives for the 108a payment account are provided in Table 1 above. Optionally in the method 300, as indicated by the broken lines in FIG. 3, in connection with transmitting the newly added 108a payment account to the incentive engine, at 304, the virtual wallet application 116 may indicate the incentives for the 108a payment account, at 312, automatically (or upon authorization from the consumer 112), so that the incentive engine 118 is not required to request such incentives from the issuer 108a.

Then, regardless of whether the incentives are received from the consumer 112 or from the issuer 108a, once received, the incentive engine 118 generates, at 314, one or more rules for the 108a payment account based on the corresponding incentives. In this particular example, the incentive engine 118 generates a first rule that indicates all purchases to a merchant with MCC 5411 (broadly, a parameter) performed using the consumer's virtual wallet (e.g., via the virtual wallet application 116, etc.) should be directed to the 108a payment account. Further, the incentive engine 118 generates a second rule (or potentially modifies the first rule) to exclude the MCC 5411 (broadly, a parameter) from the 108b payment account and the 108c payment account (which are already included in the virtual wallet). In various implementations of the method 300, the incentive engine 118 may then request approval of the rules from the consumer 112 (although this is not required in all embodiments). In various embodiments, the rules may be provided by the consumer 112 when appending the 108a payment account to the virtual wallet application 116, in which case the incentive engine 118 recognizes the rules provide by the consumer 112 as part of generating the rules, at 314.

With that said, example rules that may be generated by the incentive engine 118 for the 108a-c payment accounts included in the consumer's virtual wallet application 116 are illustrated in Table 2. As described above in the system m100, the illustrated rules are based on the assumption that each point offered via the 108b payment account is worth $0.01. It should be appreciated that the rules in Table 2 are merely exemplary in nature and that other rules related to MCC or otherwise (e.g., related to transaction amount, transaction location, transaction merchant, etc.) may be generated by the incentive engine 118 in other method embodiments.

TABLE 2

| Rule | Result |
|---|---|
| If MCC = 5411 | 108a payment account |
| If MCC ≠ 5411 and ≠ 5732 | 108b payment account |
| If MCC = 5732 | 108c payment account |
| If Merchant ID = 123456 | 108c payment account |
| If Transaction Location ≠ United States | 108a payment account |
| If Transaction Amount >$50 | 108 b payment account |
| If Wallet ID = ABC | 108a payment account |
| If Wallet ID = XYZ | 108c payment account |
| If Transaction Date = November 15 to | 108b payment account |
| December 3 | |

With continued reference to FIG. 3, if different payment accounts in the consumer's virtual wallet application 116 include similar incentives or incentives that relate to different transaction parameters, the incentive engine 118 may solicit input from the consumer 112 (i.e., an incentive preference) in generating one or more of the rules relating to a newly added payment account. For example, as described above, the 108a payment account provides 2% cash back for grocery store transactions. If another payment account in the consumer's virtual wallet application 116 provides for 20 miles per 100 dollars spent, the relative value of the incentives for the two different payment accounts may not readily be apparent to the incentive engine 118 upon appending the 108a payment account to the virtual wallet application 116, and/or may be difficult to determine. For example, the consumer 112 may travel extensively such that the 20 miles per 100 dollars spent incentive may be more valuable to the consumer 112 for purchases at grocery stores than the 2% cash back for grocery store transactions provided by the 108a payment account.

In such instances of the method 300, in connection with generating the one or more rules for the 108a payment account (at 314), the incentive engine 118 determines whether an incentive preference is required from the consumer 112, at 316. As described above, this may occur when different payment accounts in the consumer's virtual wallet application 116 include similar or the same incentives (such that the consumer's preference may relate to an issuer preference) or incentives that relate to different transaction parameters (e.g., cash back verses miles, etc.). If such an incentive preference is required from the consumer 112, the incentive engine 118 solicits the preference, at 318. In turn, the virtual wallet application 116 displays, at 320, an interface to the consumer 112, at the communication device 114, which solicits the incentive request. In so doing, the virtual wallet application 116 may also identify the different incentives for review by the consumer 112. And, in response, the consumer 112 expresses his/her incentive preference, and the virtual wallet application 116 responds to the incentive engine 118 with the incentive preference, at 322, to the incentive engine 118. The incentive engine 118 then generates the one or more rules based on the consumer's incentive preference, at 314.

Finally, once the various rules are generated, at 314, regardless of the flow for such generation, the rules are then stored in the rules data structure 120, at 324. It should be appreciated that, in various embodiments, each or some of the rules may be submitted to the consumer 112, via the virtual wallet application 116, for approval prior to being stored in the rules data structure 120.

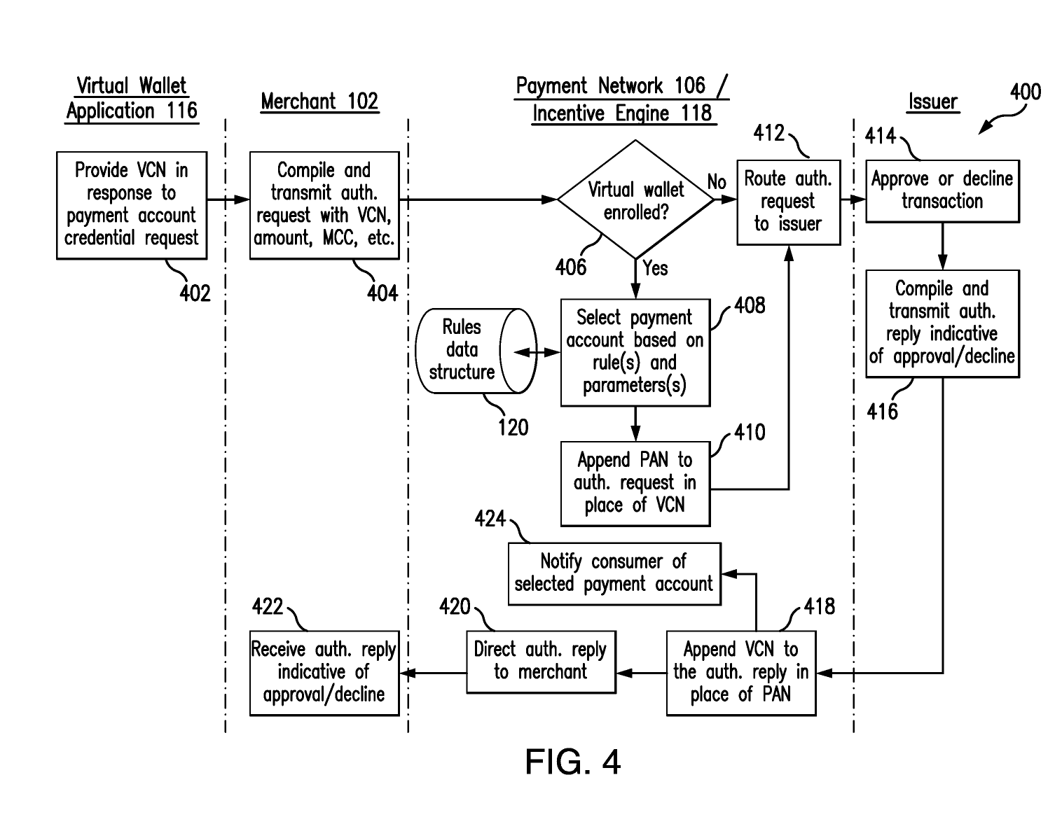

FIG. 4 illustrates an exemplary method 400 for selecting a payment account for a transaction based on an incentive associated with the payment account. The exemplary method 400 is described as implemented in the incentive engine 118 of system 100, in association with the consumer's communication device 114 and the virtual wallet application 116. However, it should be understood that the method 400 is not limited to this configuration, as the method 400 may be implemented in other parts of the system 100. As such, the methods again herein should not be understood to be limited to the exemplary system 100 or the exemplary computing device 200, and likewise, the systems and the computing devices herein should not be understood to be limited to the exemplary method 400.

For illustration, in this example method 400, the merchant 102 is defined as a grocery store and is assigned MCC 5411. However, it should be appreciated that the merchant 102 is not limited to this type of merchant and MCC, and could be any other type of merchant in other illustrations of the exemplary method 400 (with the method 400 still be applicable thereto).

In connection with a shopping experience at the merchant 102, the consumer 112 may decide to purchase a product from the merchant 102. In doing so, the consumer 112 presents the communication device 114 and/or the virtual wallet application 116 to the merchant 102, via a point of sale (POS) terminal (not shown) at the merchant 102. The POS terminal, in turn, interacts with the virtual wallet application 116, whereby the virtual wallet application 116 provides, at 402, a virtual card number (VCN) to the merchant 102 in connection with providing payment account credentials to the merchant 102 for funding the purchase. In response, the merchant 102 compiles, at 404, an authorization request for the transaction. The authorization request includes various transaction data relating to the purchase including, without limitation, the VCN for the consumer's virtual wallet application 116, an amount of the transaction (e.g., $27.95, etc.), an MCC for the merchant 102 (e.g., MCC 5411, etc.), a date of the transaction, and an identification of the product purchased, etc. Once compiled, the authorization request is transmitted from the merchant 102 to the payment network 106, via the acquirer 104 (as generally described above in the system 100).

Upon receipt of the authorization request, the payment network 106 determines, at 406, whether the authorization request for the purchase transaction includes a VCN for a virtual wallet enrolled to the incentive engine 118 (e.g., based on the VCN for the consumer's virtual wallet application 116 used in the above example transaction, etc.). If the authorization request includes the VCN for the consumer's enrolled virtual wallet application 116, as is the case in this example, the authorization request is provided to the incentive engine 118. The incentive engine 118 then selects, at 408, a payment account from the consumer's virtual wallet application 116 (from the various 108a-c payment accounts identified by the virtual wallet application 116 to the incentive engine 118, as described above), based on a rule (or multiple rules) included in the rules data structure 120 and based on parameters included in the authorization request for the purchase transaction. Upon selection of the appropriate payment account, the incentive engine 118 appends, at 410, the PAN for the selected payment account to the authorization request, in place of the VCN, and then routes, at 412, the authorization request, with the PAN appended thereto, to the issuer associated with the selected payment account. In various embodiments, in connection with appending the PAN for the selected payment account to the authorization request for the purchase transaction, the incentive engine 118 may simply overwrite the VCN with the PAN. In addition, in various embodiments where the PAN is appended to the authorization request at a different location from the VCN, the incentive engine 118 may also remove or delete the VCN from the authorization request (although this may not be required in all embodiments).

In the above example transaction between the consumer 112 and the merchant 102, the authorization request for the transaction may include the VCN for the consumer's virtual wallet application 116, the MCC 5411 for the merchant 102 (because the merchant 102 is a grocery store), and a transaction amount of $27.95 for the product purchase. Consistent with the rules in Table 2, upon receiving the authorization request, the incentive engine 118 selects (at 410) the 108a payment account (because the MCC=5411). The incentive engine then appends the PAN for the 108a payment account to the authorization request in place of the VCN and transmits the authorization request to the issuer 108a (at 412). It should be appreciated that other parameters in the transaction between the consumer 112 and the merchant 102 may result in other rules being satisfied or not satisfied in other examples (e.g., the transaction amount may trigger other rules in other examples, etc.).

While the payment network 106 and/or the incentive engine 118 are referenced herein in various parts of the method 400, it should be appreciated that one or both of the payment network 106 and/or the incentive engine 118 may perform the various operations in a number of embodiments, depending, for example, on how, or if, the payment network 106 and/or incentive engine 118 are incorporated, as referenced above with regard to FIG. 1 (e.g., depending on whether the incentive engine 118 is a standalone part of the system 100 or is at least partly incorporated in the payment network 106, etc.).

Conversely in the method 400, upon receipt of the authorization request from the merchant 102, if the authorization request does not include a VCN for an enrolled virtual wallet (or does not include a VCN at all), at 406, the payment network 106 simply routes the authorization request to the appropriate issuer for the payment account identified in the authorization request (e.g., issuer 108a-c, another issuer, etc.), at 412.

With continued reference to FIG. 4, when the issuer receives the authorization request from the payment network 106 (and/or the incentive engine 118), the issuer determines, at 414, whether to approve or decline that transaction, based on, for example, the credit and/or funds available for the payment account identified in the authorization request, fraud rules, etc. The issuer then compiles an authorization reply indicative of the approval or decline of the consumer's purchase transaction and transmits the authorization reply, at 416, to the payment network 106.

In turn, the payment network 106 intercepts (broadly, receives) the authorization reply from the issuer 108a and, as needed, appends, at 418, the VCN to the authorization reply, in place of the PAN. In particular, the payment network 106 (in conjunction with the incentive engine 118) identifies the PAN in the authorization reply and determines if the PAN is associated with a virtual wallet application enrolled to the incentive engine 118. When the PAN is associated with an enrolled virtual wallet application (e.g., based on a range of PANs being enrolled, etc.), the incentive engine 118 (and/or the payment network 106) retrieves the VCN for the identified virtual wallet application and appends it to the authorization reply in place of the PAN. As described above, the incentive engine 118 (and/or the payment network 106) may simply overwrite the PAN with the VCN. Or, where the VCN is appended to the authorization reply at a different location from the PAN, the incentive engine 118 may also remove or delete the PAN from the authorization reply.

The payment network 106 then directs, at 420, the authorization reply to the merchant 102 (via the acquirer 104). And, the merchant 102 receives the authorization reply, at 422. Further, the payment network 106 and/or incentive engine 118 notifies, at 424, the consumer 112, at the communication device 114, for example, or otherwise, about the transaction being directed to the selected payment account (e.g., the 108a payment account in the above example, etc.). The notification may be transmitted to the consumer 112 via short-message-service (SMS) messaging or email, or may be transmitted to the consumer's virtual wallet application 116.

Finally, in connection with the transaction, the issuer associated with the selected payment account (e.g., the issuer 108a in the above example, etc.), when approving the transaction, or at a later time, awards the incentives associated with the payment account to the consumer 112, based on the parameters of the transaction.

In various implementations of the method 400, when the authorization reply compiled and transmitted by the issuer 108a, at 416, includes a decline of the transaction (e.g., based on insufficient funds and/or credit at the payment account identified in the authorization request, etc.), the payment network 106 still determines, at 418, if the PAN in the authorization reply is associated with a virtual wallet application enrolled to the incentive engine 118. When the PAN is not associated with such a VCN, the payment network 106 may simply direct the authorization reply to the merchant 102 (via the acquirer 104), at 420, as described above (so that the merchant 102 can decline the transaction or request alternative forms of payment, etc.). However, when the PAN is associated with a VCN, the payment network 106 may append the VCN to the authorization reply in place of the PAN, at 418, and then direct the authorization reply to the incentive engine 118 for selection of another payment account. In so doing, the incentive engine 118 may select a different payment account from the consumer's virtual wallet application 116 (from the various 108a-c payment accounts identified by the virtual wallet application 116 to the incentive engine 118, as described above), again based on a rule (or multiple rules) included in the rules data structure 120 and based on parameters included in the authorization request for the purchase transaction (but this time excluding the previously selected payment account). The method 400 then proceeds, at 408-422, as described above. In addition in this implementation, a new rule/parameter may be added to the rules data structure 120 relating to the decline of the transaction for the originally selected payment account (such that the new rule may be applied in subsequent transactions potentially involving the originally selected payment account).

In view of the above, the systems and methods herein permit payment accounts, as included in virtual wallets, to be particularly selected for use in transactions at merchants based on underlying data for the transactions. In so doing, incentives associated with the payment accounts are evaluated against the data for the transaction, and the payment accounts to be used are then selected based on the incentives (e.g., generally relative to other incentives for payment accounts in the virtual wallets, etc.). In this manner, consumers (and/or payment networks) are able to dictate the particular conditions upon which certain payment accounts are used over others, and potentially increase, or even maximize, the incentives awarded for the given transactions. What's more, through use of the virtual wallets, the consumers are able to perform the transactions at the merchants through use of virtual card numbers, without needing to present actual account numbers/credentials to the merchants.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) receiving an authorization request for a payment account transaction at a merchant, the authorization request including a virtual card number (VCN) for a virtual wallet used in the transaction, the payment account transaction and/or the merchant associated with at least one parameter; (b) selecting one of multiple payment accounts appended to the virtual wallet, based on an incentive associated with the one of the multiple payment accounts and the at least one parameter; (c) replacing the VCN in the authorization request with a primary account number (PAN) for the selected one of the multiple payment accounts, (d) routing the authorization request, with the PAN included therein, to an issuer associated with the selected one of the multiple payment accounts, thereby permitting the transaction to be subject to the incentive associated with the selected one of the multiple payment accounts; (e) generating the at least one of the multiple rules based on the incentive associated with the one of the multiple payment accounts and an incentive and/or a lack of an incentive associated with another one of the multiple payment accounts; (f) storing the at least one of the multiple rules in the rules data structure; (g) receiving an authorization reply for the transaction in response to the authorization request from the issuer, the authorization reply including the PAN for the selected one of the payment accounts; (h) appending the VCN for the virtual wallet used in the transaction to the authorization reply, in place of the PAN; (i) transmitting the authorization reply, with the VCN included therein, to the merchant; and (j) transmitting a notification to a communication device associated with the VCN indicating the selected one of the multiple payment accounts, after selecting the one of the multiple payment accounts.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

In addition, as used herein, the term product may include a good and/or a service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in facilitating payment account transactions, the method comprising:
receiving an authorization request for a payment account transaction at a merchant, the authorization request including a virtual card number (VCN) for a virtual wallet used in the transaction, the payment account transaction and/or the merchant associated with at least one parameter;
selecting, by a computing device, one of multiple payment accounts appended to the virtual wallet, based on an incentive associated with the one of the multiple payment accounts and the at least one parameter;
replacing the VCN in the authorization request with a primary account number (PAN) for the selected one of the multiple payment accounts, and
routing the authorization request, with the PAN included therein, to an issuer associated with the selected one of the multiple payment accounts, thereby permitting the transaction to be subject to the incentive associated with the selected one of the multiple payment accounts.

2. The computer-implemented method of claim 1, wherein selecting the one of the multiple payment accounts includes:
accessing a rules data structure including multiple rules relating to incentives for the multiple payment accounts; and
selecting the one of the multiple payment accounts further based on at least one of the multiple rules.

3. The computer-implemented method of claim 2, wherein selecting the one of the multiple payment accounts further based on at least one of the multiple rules includes selecting the one or the multiple payment accounts based on the at least one parameter satisfying the at least one of the multiple rules.

4. The computer-implemented method of claim 3, further comprising:
generating, by the computing device, the at least one of the multiple rules based on the incentive associated with the one of the multiple payment accounts and an incentive and/or a lack of an incentive associated with another one of the multiple payment accounts; and
storing, by the computing device, the at least one of the multiple rules in the rules data structure.

5. The computer-implemented method of claim 4, further comprising retrieving the incentive associated with the one of the multiple payment accounts based on at least a bank identification number (BIN) for the selected one of the multiple payment accounts.

6. The computer-implemented method of claim 4, wherein generating the at least one of the multiple rules is further based on an incentive preference of a consumer associated with the multiple payment accounts.

7. The computer-implemented method of claim 1, wherein the at least one parameter includes one of a merchant category code (MCC) associated with the merchant and an amount associated with the transaction.

8. The computer-implemented method of claim 1, further comprising:
receiving an authorization reply for the transaction in response to the authorization request from the issuer, the authorization reply including the PAN for the selected one of the payment accounts;
appending the VCN for the virtual wallet used in the transaction to the authorization reply, in place of the PAN; and
transmitting the authorization reply, with the VCN included therein, to the merchant.

9. The computer-implemented method of claim 1, further comprising transmitting a notification to a communication device associated with the VCN indicating the selected one of the multiple payment accounts, after selecting the one of the multiple payment accounts.

10. A system for use in facilitating payment account transactions, the system comprising:
a memory including a rules data structure, the rules data structure including multiple rules, each of the multiple rules related to at least one of multiple payment accounts associated with a consumer; and
an incentive engine coupled to the memory and configured to:
receive an authorization request for a transaction involving a merchant, the authorization request including a parameter of the transaction and a virtual card number (VCN), the VCN associated with the consumer and the multiple payment accounts but not indicative of any one of the multiple payment accounts;
select a payment account from the multiple payment accounts for the transaction based on at least one of the multiple rules in the memory and the parameter of the transaction in the authorization request;
append a primary account number (PAN) associated with the selected payment account to the authorization request, in place of the VCN; and
route the authorization request, with the PAN appended thereto, to an issuer identified by the PAN of the selected payment account, thereby permitting the transaction to be subject to an incentive associated with the selected payment account.

11. The system of claim 10, wherein each of the multiple payment accounts is associated with at least one incentive; and
wherein the incentive engine is further configured to:
generate each of the multiple rules based on the at least one incentive of one of the multiple payment accounts relative to the at least one incentive of other ones of the multiple payment accounts; and
store each of the multiple rules in the memory.

12. The system of claim 11, wherein the incentive engine is further configured to:
receive an update of the at least one incentive of the one of the multiple payment accounts; and
update ones of the multiple rules based on the update of the at least one incentive of the one of the multiple payment accounts.

13. The system of claim 11, wherein the incentive engine is further configured to solicit the at least one incentive associated with one of the multiple payment accounts from the consumer, at a communication device associated with the consumer.

14. The system of claim 11, wherein the incentive engine is further configured to:
solicit an incentive preference from the consumer at a communication device associated with the consumer;
receive the incentive preference; and
generate at least one of the multiple rules further based on the incentive preference.

15. The system of claim 10, wherein the incentive engine is further configured to:
receive an authorization reply for said transaction from the issuer identified by the PAN of the selected payment account; and
append the VCN to the authorization reply, in place of the PAN, prior to directing the authorization reply to the merchant.

16. The system of claim 10, wherein the VCN includes a same format as the PAN.

17. A non-transitory computer readable storage media including executable instructions for facilitating payment account transactions to particular payment accounts, which, when executed by a processor, cause the processor to:
generate at least one use rule for each of multiple payment accounts included in a virtual wallet for a consumer, the at least one rule based on an incentive for the corresponding payment account;
receive an authorization request for a transaction involving a merchant and performed using the virtual wallet, the authorization request including a parameter of the transaction and a virtual card number (VCN) associated with the virtual wallet but not indicative of any one of the multiple payment accounts included in the virtual wallet;
select a payment account from the multiple payment accounts included in the virtual wallet for use in the transaction, based on application of the at least one use rule for each of the multiple payment accounts to the parameter of the transaction;
append a primary account number (PAN) associated with the selected payment account to the authorization request, in place of the VCN; and
route the authorization request, with the PAN appended thereto, to an issuer identified by the PAN of the selected payment account, thereby permitting the transaction to be subject to an incentive associated with the selected payment account.

18. The non-transitory computer readable storage media of claim 17, wherein the executable instructions, when executed by the processor, further cause the processor to solicit the incentive associated with at least one of the multiple payment accounts from the consumer, at a communication device associated with the consumer.

19. The non-transitory computer readable storage media of claim 17, wherein the executable instructions, when executed by the processor, further cause the processor to:
solicit an incentive preference from the consumer, at a communication device associated with the consumer, upon receiving the authorization request for the transaction; and
receive the incentive preference; and
wherein the executable instructions, when executed by the processor, further cause the processor, in connection with selecting a payment account from the multiple payment accounts included in the virtual wallet for use in the transaction, to select the payment account based on the incentive preference received from the consumer.

20. The non-transitory computer readable storage media of claim 17, wherein the executable instructions, when executed by the processor, further cause the processor to:
receive an authorization reply for said transaction from the issuer identified by the PAN of the selected payment account;
append the VCN to the authorization reply, in place of the PAN; and
route the authorization reply, with the VCN appended thereto, to the merchant.
